(19) United States
(12) Patent Application Publication
(10) Pub. No.: US 2001/0041781 A1
(43) Pub. Date: Nov. 15, 2001

(54) Methoxy-functional organopolysiloxanes, their preparation and use

(76) Inventor: Gerhard Reusmann, Essen (DE)

Correspondence Address: William F. Lawrence, Esq., c/o FROMMER LAWRENCE & HAUG LLP, 745 Fifth Avenue, New York, NY, 10151, US

(21) Appl. No.: 09/825,919

(22) Filed: Apr. 4, 2001

(30) Foreign Application Priority Data
Apr. 6, 2000 (DE) 100 17 212.1

(51) Int. Cl. C08G 77/00

(52) U.S. Cl. 528/10

(57) ABSTRACT

The invention relates to methoxy-functional organopolysiloxanes having a narrow molecular weight distribution with an average molecular weight (MW)≦2000 g/mol and of the general formula

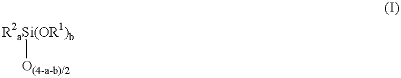

where R¹ is a methyl group, R² denotes different radicals, comprising the phenyl radical and alkyl radicals having 1 to 4 carbon atoms, a is from 1 to 1.7 and b≦1, at least 80% of the polysiloxane having a molecular weight between 800 and 2000 g/mol, to a process for their preparation and to their use as coating constituents in corrosion protection coatings.

### RELATED APPLICATIONS

This application claims priority to German application 100 17 212.1, filed Apr. 6, 2000.

### BACKGROUND OF THE INVENTION

1. Field of the Invention

The present invention relates to methoxy-functional organo-polysiloxanes having a narrow molecular weight distribution with an average molecular weight≦2000 g/mol which has the general formula

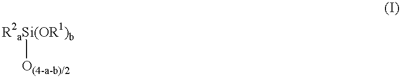

where R¹ is a methyl group, R² independently is a phenyl radical and/or an alkyl group, preferably having 1 to 4 carbon atoms, a is from 1 to 1.7 and b≦1, their preparation and their use.

2. Description of the Related Art

In the descriptions which follow, silicone resins, poly-siloxanes and organopolysiloxanes have the same definition; mutatis mutandis.

The German Laid-Open Specifications DE-A-32 14984 and DE-A-32 14985 describe processes for preparing silicone resins which feature the use, inter alia, of alkoxysiloxanes of the above mentioned formula (I) in which R¹ is a lower alkyl radical having up to 4 carbon atoms and R² is an alkyl or phenyl group, a is from 1.0 to 1.2 and b is from 0.5 to 1.0, with the proviso that at least 50% by weight correspond to the formula [R²Si(OR¹)O]ₙ, n being from 3 to 8. The alkoxysilanes used are predominantly of low-molecular mass and are formed from the corresponding chlorosilane with alcohol/water at reaction temperatures from 20 to 60° C.

In DE-A-28 28 990, which provides for the preparation of heat-curable silicone resins, use is likewise made of alkoxysilanes which correspond to the formula mentioned above, in which R¹ and R² have the stated definition and a is from 1 to 1.5 and b is from 0.1 to 0.7.

Important features in determining the final properties exhibited by the cured silicone resins or silicone combination resins are the organic radical R² and the R²/Si ratio. For this reason it is frequently desirable to use not only organotrichlorosilane but also fairly large amounts of diorganodichlorosilane and also, if appropriate, triorganochlorosilane. Owing to the different reactivity of the organotrichlorosilanes on the one hand and of the diorganodichloro- and/or triorganochlorosilanes on the other, cohydrolysis/cocondensation leads frequently to a hard-to-reproduce mixture of alkoxysiloxanes which, although corresponding on average to the specified formula, are nevertheless very different in terms of the composition of the individual molecules and the distribution of the molecular weights. Silicone resin precursors of this kind result in unfavorable properties in the silicone resins or silicone combination resins produced from them. These unfavorable properties include, for example, long cure times.

In accordance with DE-C-34 12 648, such silicone resins with low average molecular weights and narrow molecular weight distribution are obtained by reacting organotrichlorosilanes, diorganosiloxanes of the formula

RO—[R′₂—SiO—]ₙR and, if appropriate, triorganochlorosilane and/or hexaorganodisiloxane at temperatures >40° C.

Although the general formula stated for the process products does include methoxy-functional polysiloxanes, such polysiloxanes cannot in fact be prepared by the process indicated in the narrow molecular weight distribution required. What are described, therefore, are exclusively ethoxy-functional polysiloxanes.

Because of their low reactivity in condensation reactions, ethoxy-functional organosiloxanes are not suitable for the formulation of air-drying coatings. Thus, such coatings have inadequate hardness. If it is attempted, however, to prepare the more reactive methoxy-functional organopolysiloxanes by the process described, this leads to resin products having a broad molecular weight distribution, and in some cases to gelling, these products being unsuited to the formulation of coating systems.

To formulate high-solids coating systems, it is very important to use low-viscosity binders in order to obtain the low viscosity required for the processing properties. Accordingly, for coatings of this kind, it is preferred to use organopolysiloxanes having an average molecular weight of between about 500 and about 2000 g/mol. At organopolysiloxane molecular weights below about 500 g/mol, the high fraction of reactive alkoxy groups results in inadequate storage stability of the liquid coating material; molecular weights above about 2000 g/mol do not allow the formulation of high-solids materials, owing to the significantly high viscosities. Owing to the significantly lower fraction of reactive alkoxy groups, the coatings exhibit inadequate hardnesses after air-drying.

Particularly suitable for the formulation of corrosion protection coatings are phenylmethylsilicone resins. Whereas straight methylsilicone resins lack adequate compatibility with organic binders, for example, such as epoxy resins, and there are in some cases separation phenomena, straight phenylsilicone resins are unsuited to the formulation of corrosion coatings with sufficient hardnesses. Especially preferred corrosion protection coatings are those comprising by phenylmethylsilicone resins in which the methyl/phenyl mass ratio of the group R² in the formula (I) varies from about 5:95 to about 95:5, with particular preference from about 10:90 to about 90:10.

The air drying of the coating system requires high reactivity of the silicone resin. Only through the use of methoxy-functional silicone resins can the reactivity required for air drying of the coating at temperatures around 10-30° C. be achieved. The use of alkoxy-functional organosiloxanes with alkoxy groups of higher molecular mass, such as ethoxy or propoxy groups for example, leads to coatings having longer drying times and inadequate hardnesses.

Accordingly for the formulation of corrosion protection coatings with high solids contents, particularly suitable resins are low molecular mass, methoxy-functional phenylmethylsilicone resins with a narrow molecular weight distribution.

It is methoxy-functional silicone resins of this kind, among others, that are provided by the invention.

The concept of maximum molecular uniformity defines, in particular, those products whose individual members corresponding in terms of their amounts to an extremely narrow Gaussian distribution. By low molecular mass products are meant in particular those products whose average molecular weight does not exceed a value of about 2000 g/mol. The intention in particular is to prepare those organoalkoxysiloxanes having an R²/Si ratio of from about 1.0 to about 1.7.

### DESCRIPTION OF THE INVENTION

The invention accordingly provides/or methoxy-functional organopolysiloxanes having a narrow molecular weight distribution with an average molecular weight (MW)≦about 2000 g/mol and of the general formula

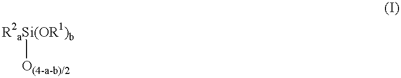

where R¹ is a methyl group, R² independently phenyl and/or an alkyl radical, preferably having 1 to 4 carbon atoms, a is from 1 to 1.7 and b≦1, wherein at least 80% of the polysiloxane having a molecular weight between about 800 and about 2000 g/mol.

Preferably, R² includes methyl and phenyl groups. A particularly preferred organopolysiloxane is a methyl-functional methylphenylsilicone resin.

The invention additionally provides a process for preparing the organopolysiloxanes of the invention, which comprises conducting the reaction of silanes of the formula

R²SiX₃,

and, if desired,

R²₂SiX₂,

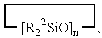

or

R³O[R²₂SiO—]ₙR³,

(R²)₃SiX,

(R²)₃Si—O—Si—(R²)₃,

and/or their hydrolysates,

where

X is a hydrolyzable group such as chlorine or a low molecular mass alkoxide residue with 1 to 6 carbon atoms, and R² and R³ are each an alkyl group having 1 to 6 carbon atoms or are each a phenyl group, and n is from 1 to 500, such that in a first step the organotrichlorosilane R²SiX₃ with the greatest reactivity is reacted with methanol or methanol/water to the extent that from 1 to 2 equivalents of the hydrolyzable groups X are reacted, and in a second step the less reactive silanes are added to the reaction mixture and are then reacted with further methanol/water to give the end product.

Low molecular mass methoxy-functional phenylmethylsilicone resins of this kind possess particularly advantageous performance properties. Corrosion protection coatings formulated from them exhibit high hardnesses and thus good mechanical resistances, and also good drying rates. The narrow molecular weight distribution permits the formulation of coating systems having solids contents of from 90 to 100%.

Furthermore, then, the invention provides for the use of the low molecular mass, methoxy-functional phenylmethylsilicone resins of the invention as a coating constituent in corrosion protection coatings.

### WORKING EXAMPLES

### Example 1

### Methoxy-functional Polysiloxane

(Inventive Preparation)

36.0g (1.13 mol) of methanol were slowly added with stirring to 112.1 g (0.75 mol) of methyltrichlorosilane. In the course of the addition, the temperature fell to about 0° C.. Subsequently, 63.5 g (3.0 mol) of phenyltrichlorosilane were added dropwise with stirring. The reaction mixture was warmed to about 35° C. Following the addition of phenyltrichlorosilane, 61.2 g of a mixture of methanol/water (weight ratio 2:1, corresponding to 1.3:1.1 mol) were added and the mixture was stirred for 2 hours. After the end of the addition, the reaction mixture is distilled at 16 mbar.

The analytical data of the phenylmethylmethoxysiloxane was as follows:

Silicone resin I: viscosity: 85 mm²/s at 25° C., methoxy content: 26% by weight (theoretical: 28%)

### Example 2

### Ethoxy-functional Polysiloxane

(Noninventive Preparation According to DE-C-34 12 648)

160 g (3.5 mol) of ethanol were slowly added to 211.5 g (1 mol) of phenyltrichlorosilane. Then 85.5 g of methylethoxypolysiloxane of the formula CH₃SiO_{1.25}(OC₂H₅)_{0.5} were added and the reaction mixture was heated to 60° C. After 15 minutes, 17.1 g (0.95 mol) of water are added dropwise. After the end of the addition of water, the reaction mixture was distilled at 16 mbar.

The analytical data of the phenylmethylethoxysilane are as follows:

Silicone resin II: viscosity: 95 mm²/s at 25° C., ethoxy content: 27% by weight (theoretical 28.2%).

### Example 3

### Methoxy-functional Polysiloxane

(Noninventive Preparation According to DE-C-34 12 648)

112 g (3.5 mol) of methanol were slowly added to 211.5 g (1 mol) of phenyltrichlorosilane. Then 78.0 g of methylmethoxypolysiloxane of the formula CH₃SiO_{1.25}(OCH₃)_{0.5} were added and the reaction mixture was heated to 60° C. After 15 minutes, 17.1 g (0.95 mol) of water were added dropwise. After the end of the addition of water, the reaction mixture was distilled at 16 mbar. This gave a nonuniform product having a high gel content, which cannot be formulated to give any uniform coating.

The features of the present invention are illustrated by the following examples. The amounts used in the formulations are parts by weight.

Analysis Methods:

QUV test

The QUV test was conducted with an instrument from the QUV Company. The test was carried out over a period of 2000 hours with an alternating cycle of 4 hours of irradiation and 4 hours of water condensation. The black standard temperature was 50° C.

Adhesion

Adhesion testing was carried out by the cross-cut test according to DIN ISO 2409.

Yellowing Resistance

The yellowing was determined by measuring the Δb value before and after QUV exposure, in accordance with the Hunter L a b system, for a white coating.

Gloss

The gloss was measured in accordance with DIN 67 530.

Storge Stability

For the determination of the storage stability after 4 weeks at 40° C., stability of the viscosity, clouding, separation phenomena and processing properties were assessed.

Hardness

The pencil hardness was determined in accordance with ECCA standard No. 14.

Corrosion Protection Effect

The corrosion protection effect was determined by means of a salt spray test according to DIN 53167 (for coatings) of a steel panel (Q-Panel R 46) coated with the coating. The coatings were scored down to the metal substrate and the degree of subfilm creep after 2000 hours of salt spray testing is assessed.

0: no subfilm corrosion creep after salt spray test;

1: maximum of 2 mm subfilm corrosion creep after salt spray test;

2: maximum of 2-5 mm subfilm corrosion creep after salt spray test;

3: more than 5 mm subfilm corrosion creep after salt spray test.

Test Formulations

The composition of the test formulation is summarized in Table 1. The numerical values reported refer to amounts in grams.

To prepare the stock coating material, the formulating constituents 3 to 9 are mixed with one another in succession and combined intensively in a bead mill for 2 hours. This is followed by the addition of component 1, or respectively, component 2, with stirring.

TABLE 1
Composition of the test formulations (amounts in g)

| | | | | |
|---|---|---|---|---|
| | Formu- | Formu- | Formu- | Formu- |
| | lation I | lation II | lation III | lation IV |
| | (inven- | (compara- | (inven- | (compara- |
| No. | tive) | tive) | tive) | tive) |

Stock coating material

| | | | | | |
|---|---|---|---|---|---|
| 1 | Silicone resin I | 34.0 | — | 34.0 | — |
| | (Ex. 1) | | | | |
| 2 | Silicone resin II | — | 34.0 | — | 34.0 |
| | (Ex. 2) | | | | |
| 3 | ¹Epoxy resin | 31.0 | 31.0 | 31.0 | 31.0 |
| | Epilox M700 | | | | |
| 4 | ²Tetraethoxysilane | 2.2 | 2.2 | — | — |
| | Silicic acid ester | | | | |
| | A29 | | | | |
| 5 | ³Methyltri-meth- | — | — | 2.2 | 2.2 |
| | oxysilane | | | | |
| | A-163 | | | | |
| 6 | Heliogen blue | 2.0 | 2.0 | 2.0 | 2.0 |
| 7 | Kronos 2059 | 27.0 | 27.0 | 27.0 | 27.0 |
| 8 | Talc (microtalc) | 2.0 | 2.0 | 2.0 | 2.0 |
| | AT extra | | | | |
| 9 | Aerosil 380 | 1.0 | 1.0 | 1.0 | 1.0 |
| | (Degussa) | | | | |

Curing agent

| | | | | | |
|---|---|---|---|---|---|
| 10 | ⁴AMEO, | 17.0 | 17.0 | 17.0 | 17.0 |
| | (3-Amino- | | | | |
| | propyltriethoxy- | | | | |
| | silane) | | | | |

(¹Leuna AG, ²Wacker AG, ³Witco OrganoSilicones, ⁴PCR Incorporated, USA)

In order to adjust the processing viscosity, it is posible if necessasry to add solvents such as ethanol, for example, to the formulation.

Prior to application to the substrate, stock coating material and curing agent are mixed intensively with one another.

The test formulations obtained were applied at a dry film thickness of approximately 120-160 μm to a sandblasted steel panel coated with the zinc-rich paint EP (60 μm) from Feidal (D) and the coated panel is dried at 25° C. for 10 days.

Performance Testing

The results of the performance testing of formulations I, II, III and IV are set out in Table 2:

TABLE 2
Performance properties of the test formulations

| | Formu- | Formu- | Formu- | Formu- |
|---|---|---|---|---|
| | lation I | lation II | lation III | lation IV |
| | (inven- | (compara- | (inven- | (compara- |
| | tive) | tive) | tive) | tive) |
| Dry film thickness | 140 | 140 | 140 | 140 |
| (μm) | | | | |
| Drying time | 8 | >20 | 9-10 | >20 |
| (Days at 25° C.) | | | | |
| QUV (weathering) | | | | |
| Gloss 60° | | | | |
| Control: | 85 | 82 | 83 | 80 |
| 5000 hours: | 81 | 55 | 78 | 58 |
| Hardness | 2H | 3B | HB | 3-4B |
| (pencil hardness) | | | | |
| Yellowing after 2000 | 0.02 | 0.03 | 0.02 | 0.03 |
| hours QUV | | | | |
| (Δ b) | | | | |
| Adhesion to substrate | 0 | 1-2 | 0-1 | 1-2 |
| (GtC) | | | | |
| Storage stability stock | sat. | sat. | sat. | sat. |
| coating material | | | | |
| (4 weeks at 40° C.) | | | | |
| Corrosion protective | 0 | 2 | 1 | 2-3 |
| effect (2000 h) | | | | |

(sat.: satisfactory, unsat. unsatisfactory)

From Table 2, the superiority of the inventinve formulation I is clear.

In comparison to formulation II, based on the noninventive silicone resin II, formulation I exhibits much shorter drying times and much higher hardnesses. Likewise, the corrosion protection effect was greatly improved.

From a comparison of the inventive formulations I and III (in analogy to WO 96/16109), moreover, the superiority of corrosion protection coatings when using tetraalkoxysilanes in comparison to trialkoxysilanes as described in the patent WO 96/16109 becomes clear. Thus after 8 days of air drying at 25° C., an improved corrosion protection effect and improved adhesion to the substrate are found.

Accordingly, by using the inventive silicone resin I and tetraalkoxysilanes, it is possibile to achieve particularly advantageous coating properties.

The coating of the invention may be applied by one-coat coating, by rolling, spraying or dipping, for example, and thus shows processing advantages over the two-layer epoxy-polyurethane coatings which are common and known to the skilled worker.

The above description of the invention is intended to be illustrative and not limiting. Various changes or modifications in the embodiments described herein may occur do those skilled in the art. These can be made without departing from the scope and spirit of the invention.

What is claimed is:

1. A methoxy-functional organopolysiloxane having a narrow molecular weight distribution with an average molecular weight (M_{W})≦about 2000 g/mol and of the general formula 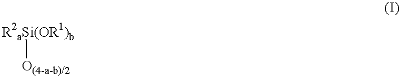
where
R¹ is a methyl group,
R² independently is an phenyl radical or an alkyl radical,
a is from 1 to 1.7 and
b≦1,
wherein
at least 80% of the polysiloxanes have an average molecular weight of between about 800 and about 2000 g/mol.

2. The methoxy-functional organopolysiloxane according to claim 1, wherein R¹ is a methyl group; R² independently is a phenyl radical or a C₁-C₄-alkyl radical.

3. The methoxy-functional organopolysiloxane as claimed in claim 1, wherein R² includes methyl and phenyl groups.

4. The methoxy-functional organopolysiloxane as claimed in claim 2, wherein the average molecular weight is ≦2000 g/mol and at least 80% of the polysiloxanes have an average molecular weight between 800 and 2000 g/mol.

5. A process for preparing a methoxy-functional organopolysiloxane as claimed in claim which comprises:
1. selecting one or more different silanes of the formula
R²SiX₃,
and, optionally,
R₂SiX₂, 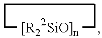
R³O[R²₂SiO—]ₙR³,
(R²)₃SiX,
(R³)₃Si—O—Si—(R²)₃,
or a hydrolyslate thereof
wherein
X is a hydrolysable group,
R² and R³ independently are alkyl or phenyl groups, and
n is from 1 to 500
and determining which of the one or more different silanes is the most reactive out of those selected;
2. reacting the silane with the most reactivity with methanol and water to the extent that from 1 to 2 equivalents fo the hydrolyzable groups X are reacted per molecule.
3. adding the one or more of the less reactive silanes to the reaction mixture and further reacting this mixture with methanol and water.

6. The process according to claim 5, wherein Y is chlorine or a low molecular mass alkoxide residue having 1 to 6 carbon atoms; R² and R³ independently are an alkyl group having 1 to 6 carbon atoms.

7. A protection coating compostion which comprises a methoxy-functional organopolysiloxane according to claim 1.

8. A method for reducing the corrosion for a substrate which comprises applying a protection coating composition according to claim 7, to the substrate.

9. The method according to claim 8, wherein the substrate is metallic.

10. A substrate which is coated with the protection coating composition according to claim 7.
